(19) United States
(12) Patent Application Publication
(10) Pub. No.: US 2018/0032633 A1
(43) Pub. Date: Feb. 1, 2018

(54) SYSTEM AND METHODS FOR RETRIEVING DATA USING SECONDARY XML FILE GENERATION AND MULTIPLE PORTLETS

(71) Applicant: ALQIMI Analytics & Intelligence, LLC, Rockville, MD (US)

(72) Inventors: Walter GREENBERG, Rockville, MD (US); Kevin M. DONOHUE, Rockville, MD (US)

(21) Appl. No.: 15/224,432

(22) Filed: Jul. 29, 2016

(51) Int. Cl. G06F 17/30; H04L 29/08

(52) U.S. Cl. CPC G06F 17/30941; H04L 67/34; G06F 17/30938; G06F 17/30914

(57) ABSTRACT

Some embodiments are directed to a method for exchanging data between a user terminal and a data source. The method includes generating a first XML configuration file in accordance with a data source query and generating a second XML configuration file in accordance with options specified in the first XML configuration file. The method further includes configuring a plurality of portlets on a portal server based on the first XML configuration file and the second XML configuration file, and retrieving data from the data source via the plurality of portlets operating on the portal server and an application server. The method further includes storing the in a database, and displaying the data on the portal in accordance with the options specified in the first XML configuration file.

### BACKGROUND

The disclosed subject matter relates to data retrieval, and more specifically to a system and methods for displaying data retrieved from data sources on a web portal. In particular, the disclosed subject matter relates to a portal with one or more portlets that are designed to display information from diverse data sources. Retrieved data is typically presented in web pages or web-based graphical user interfaces.

Services relating to data retrieval can be implemented as software components that provide content and/or functionality to remote web applications through the Internet. Remote applications can submit requests for information to web services and receive content in return. Similarly, applications can pass queries to web services by deploying configuration files that contain information regarding the data source, various search filters and display options. A result is returned from the web service to the application based on the queries. Web service content can be passed to a client of the application where it can be displayed, processed, or otherwise utilized.

### SUMMARY

Various applications for retrieving data from data sources and displaying the retrieved data on user terminals or client terminals are known. However, each application can retrieve only a specific type of data or data from a specific data source. Further, such applications also need to be present locally on a user terminal or a client terminal.

Some related arts access data from multiple data sources and store the retrieved data in a data warehouse. The data stored on the data warehouse is then displayed on the client or user terminals. However, the data stored in the data warehouse may be in a raw format and further formatting of the data is required before the data can be displayed. Further, data retrieval processes are generally implemented by an application server. An application server can be any software framework that facilitates the creation of web applications and a server environment to run them. It behaves as a virtual machine to run applications and handles connections to data sources on one end, and connections to the client terminal or user terminal through a web client or web portal on the other end. Often, using only an application server or a cluster of application servers can limit the dynamic delivery of information. Additional processing functions need to be performed by an end-user or client to obtain information in a customized format. Complex client applications are required to process the data retrieved.

Some related arts use applications present on the client terminals to format and display retrieved data. However, such applications format the retrieved data based on predetermined algorithms without providing any option to an end-user to control the presentation of the retrieved data.

It may therefore be beneficial to provide systems and methods to retrieve data from one or more data sources and display the data in accordance with user-defined display options and data retrieval filters. Specifically, it may be beneficial to generate one or more portlets to facilitate retrieval of data in a legible format without using any applications stored locally on a client or user terminal. One or more portlets are generated by a portal server to facilitate a single point of access to data from data sources for end-users or clients.

It may also be beneficial to provide systems and methods to retrieve data from multiple data sources and store the retrieved data in a database in a predetermined format. The stored data is displayed in accordance with user-defined display options and data retrieval filters without the need for any local applications or programming to format the retrieved data.

It may also be beneficial to provide a specification-compliant, end-user-configurable portlet that allows a user terminal to quickly access and return database data using a portal server and present it in a useful format, without programming. Using a web-interface designed for a non-technical end-user, a series of data-presentation options may be selected or configured and saved to an XML (Extensible Markup Language) configuration file. A portal server, with the portlet installed, may be used to present a view of the data as per the configuration options stored in the XML configuration file. Examples of available configuration options include data retrieval filters, data export formats (XML format, Comma Separated Values or CSV format), and various levels of summary and detail.

It may also be beneficial to provide methods enabling a user terminal to create one or more configuration files which dictate certain display options. For example, each configuration file corresponds to a specific user's desired data feeds and/or display options.

Some embodiments are directed to a method for exchanging data between a user terminal and a data source. The method includes generating a first XML configuration file in accordance with a data source query received from the user terminal; generating a second XML configuration file in accordance with options specified in the first XML configuration file; configuring a plurality of portlets on a portal server based on the first XML configuration and the second XML configuration file; and retrieving a set of data from the data source via the plurality of portlets operating on the portal server, the plurality of portlets communicating with an application server and the portal, wherein the application server is communicably coupled to the data source. The method further includes storing the set of data in a database, and displaying the set of data on the portal in accordance with the options specified in the first XML configuration file.

Some other embodiments are directed to a method of retrieving data from a data source, the method including receiving a set of display options and a set of data retrieval filters from a user terminal via a user interface on a portal, wherein the set of display options and the set of data retrieval filters correspond to the data source; embedding the set of data retrieval filters and the set of display options into a first XML configuration file; generating a second XML configuration file based on the first XML configuration file, wherein the second XML configuration file includes connection information for connecting with the data source; and retrieving a set of data from the data source in accordance with the set of data retrieval filters embedded in the first XML configuration file and the connection information specified in the second XML configuration file. The method further includes storing the set of data in a database in accordance with a predefined format, and generating one or more data portlets to display the set of data to the user in accordance with display options specified in the first XML configuration file, wherein the one or more portlets are communicably coupled to an application server and the user interface.

Yet other embodiments are directed to a system for exchanging data between a user terminal and a data source, the system comprising a portal configured to receive a data source query from the user terminal, the data source query corresponding to a data source; a processor configured to generate a first XML configuration file based on the data source query, the first XML configuration file including a set of display options and a set of data retrieval filters; and a portal server communicably coupled to the portal; the portal server configured to generate a second XML configuration file based on one or more parameters specified in the first XML configuration file, the second XML configuration file including connection information for connecting with the data source. The portal server is further configured to retrieve a set of data from the data source in accordance with the set of data retrieval filters embedded in the first XML configuration file and the connection information specified in the second XML configuration file; store the set of data in a database; and generate one or more data portlets to display the set of data on the portal in accordance with the display options specified in the first XML configuration file.

As mentioned above, the disclosed systems and methods address a problem occurring in related art processing devices that utilize data retrieval or display software, and in particular systems that employ data portal (portlet) applications. Specifically, differing databases can have myriad configuration options that need to be specified, which can be done in a configuration file. These options allow functions such as searching, retrieval, formatting and display of data to be accurately executed. The situation can be compounded by applications that are attempting to query multiple databases, and in data portlet applications, generating numerous (multi-portlet) portlet display configurations, each of which may retrieve data from separate database sources with different configuration options.

Some of the disclosed embodiments address this problem by providing methods and systems allowing a user to generate separate XML files—a first file that outlines functions such as data display, query search terms, etc., and a second XML configuration file that manages connections to one or more data sources such as a database. Utilizing these tools, a computer can be caused to create a first XML file, and then to extrapolate information from the first XML file to generate a second XML file. This could be done based solely on information contained in the first XML file, or could occur as a result of a query to a database the user desires to access. A connection manager could then ascertain which setting are the most appropriate to include in the XML file and subsequently generate the second XML file. Of course, the “second” XML file could actually be numerous individual XML files, each configured to a separate data source. Thus, the first XML file may provide information such as “John Smith” (query target) and various display options, and the second (or more) XML files could be generated to connect to the requested databases. Future queries (say, for “Jane Smith”) could then either re-use the “second” configuration XML file(s), or could generate new XML configuration files for data sources not used in the original query for “John Smith”.

Additionally, either or both of the configuration files can be used to spawn a multi-portlet query, in which two or more data portlets are spawned. These multi-portlets could arise from two or more data sources, or could include spawning multiple portlets from a same data source with different query terms associated with each. In either case, the first XML configuration file could manage the display and query configuration options, while the second (or more) configuration file(s) could manage the individual connection configuration options with each individual data source. By using this strategy, a processor can be made to be more accurate and efficient, because the first XML configuration file acts like a driver: setting the mirrors, radio, air conditioner, etc. to their liking, while the second (or more) XML configuration file(s) act as the interface between the driver and a given automobile (is it manual or automatic transmission? Is it a monster truck or a limousine? Is it a racecar—if so formula 1 or stock car racing? . . . etc). By generating the second XML file, any new driver (first XML configuration file) can use existing interfaces, or if the interface is new, learn to “drive” the new one.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIGS. 1A, 1B and 1C illustrate various exemplary systems for retrieving and displaying data with a Data Integration Portlet (DIP) in accordance with the disclosed subject matter.

FIG. 2 illustrates the Data Integration Portlet (DIP) in accordance with the disclosed subject matter.

FIG. 3 is a schematic of a user interface shown on a portal page in accordance with the disclosed subject matter.

FIG. 4 illustrates an exemplary embodiment of the Data Integration Portlet (DIP) in accordance with the disclosed subject matter.

FIG. 5 is a flowchart of an exemplary method of retrieving data in accordance with the disclosed subject matter.

FIG. 6 is a flowchart of an exemplary method of retrieving data in accordance with the disclosed subject matter.

FIG. 7 is a computer system that can be used to implement various exemplary embodiments of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

I. Server Environment

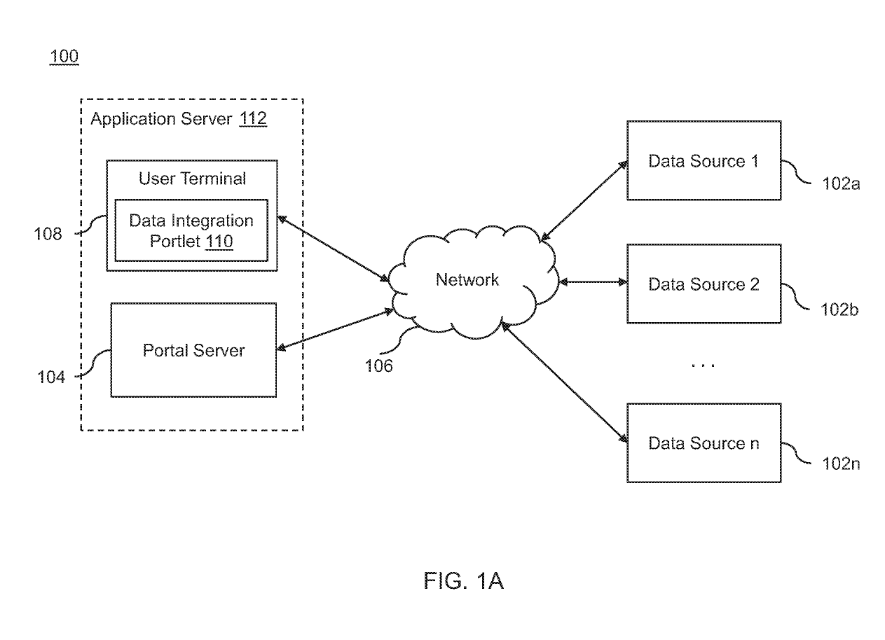

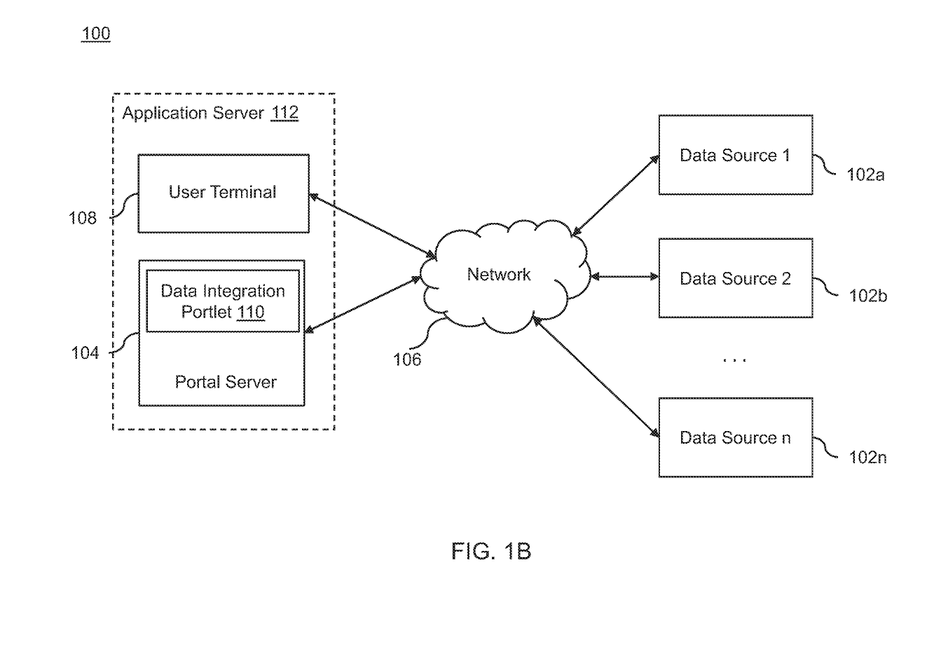

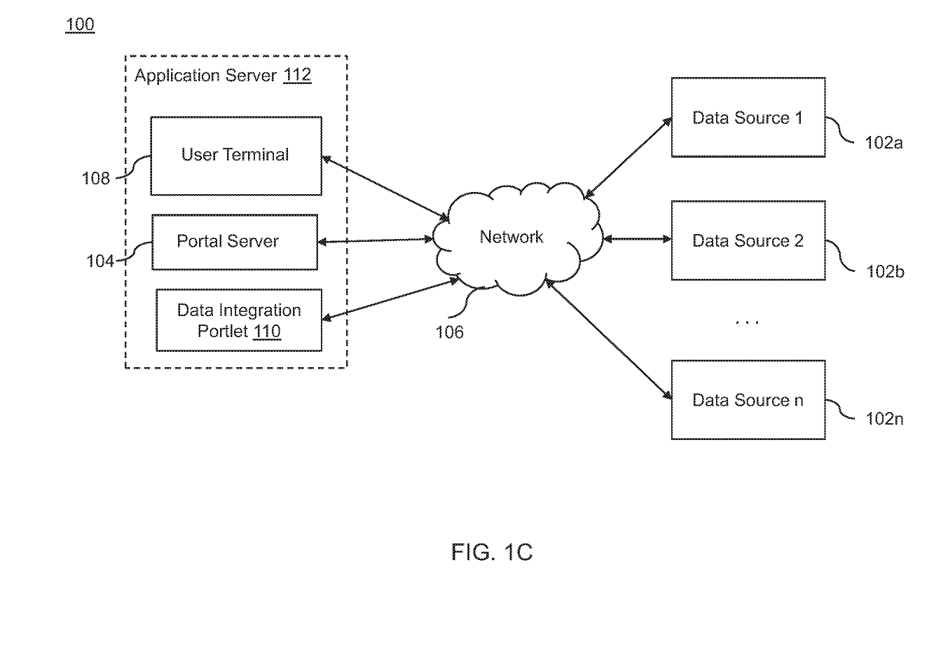

FIG. 1A is an illustration of a system 100 in accordance with the disclosed subject matter. The system 100 is configured to retrieve and display data. Specifically, the system 100 facilitates exchange of data between a user terminal 108 (hereinafter user terminal 108) and one or more data sources 102a to 102n (hereinafter collectively referred to as “the data sources 102”) through one or more portlets installed on a portal server 104. The portal server 104 further runs on an application server 112. The application server 112 is configured to be a platform for the portal server 104, and is communicably coupled to the data sources 102. Specifically, the application server 112 provides an environment in which the portal server 104 can operate. In some instances, the portal server 104 may be positioned in series with the user terminal 108, or may even be configured as a part of the user terminal 108 itself (such as an app, Operating System routine, or the like). The data to be exchanged is retrieved in accordance with an Extensible Markup Language (XML) configuration file that may contain various forms of information. This information can include, but is not limited to, connection information, display preference information, and data source query information. The XML file can also include data retrieval filters, keywords, metadata or metadata tracking information and so forth.

The data sources 102 are intended to be any type of data source including social media networks, search engines, portals, remote servers, network storage units, etc. Embodiments are also intended to include or otherwise cover any other type of data source. The data sources 102 are merely provided for exemplary purposes, and the various inventive aspects are intended to be applied to any type of data source on a network 106 connected to a portal server 104, the application server 112 and the user terminal 108.

The network 106 may include a data network such as, but not restricted to, the Internet, local area network (LAN), wide area network (WAN), metropolitan area network (MAN), etc. In certain embodiments, the communication network 106 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the communication network 106 may include or otherwise cover networks or subnetworks, each of which may include, for example, a wired or wireless data pathway. The communication network 106 may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network includes a cellular telephone network configured to enable exchange of text or SMS messages.

Examples of the network 106 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the data sources 102, the portal server 104 and the user terminal 108 with each other.

The user terminal 108 is intended to include any electronic device, such as desktop computers, portable computers, smartphones, tablet computers, wearable devices, and the like. The user terminal 108 may also include a display unit (not shown) for displaying any data. The display unit can include, but not limited to, a Cathode Ray Tube (CRT) display, a Liquid Crystal Display (LCD), a Light Emitting Diode (LED) display, and the like. Embodiments are intended to include or otherwise cover any type of display, including known, related art, and/or later developed technologies.

The portal server 104 generates a Data Interchange Portlet 110 (hereinafter referred to as “the DIP 110”) that is a specification-compliant, end-user-configurable portlet that allows the user terminal 108 to quickly access and return data using the portal server 104 and present the data in a useful format, without any substantial programming beyond the generation of the XML configuration file. In some embodiments, the DIP 110 may be part of the user terminal 108, as seen in FIG. 1A. In some other embodiments, the DIP 110 may be part of the portal server 104 (shown in FIG. 1B) or may be placed next to the user terminal 108 (shown in FIG. 1C). As described above, the portal server 104 further runs on the top of the application server 112.

Through a web-interface designed for a non-technical end-user, a series of data-presentation options may be selected (configured) and saved into an XML configuration file. The XML configuration file can also be manually configured. For example, the XML configuration file may be configured in a word processing application. The portal server 104, with the DIP 110 installed, is used to present a view of the data as per the configuration options stored in the XML configuration file. Examples of available configuration options include data retrieval filters, data export formats (XML format, csv format), and various levels of summary and detail. The XML configuration file may also include artistic guidelines, such as displaying a three-day weather forecast in the top-left corner of a portal page, and news in the bottom-right corner of the portal page. The XML file may also be arbitrarily specific, such as weather in Seattle being displayed in the top left of the portal page, while arrest reports from anyone in Miami named “Edward” being displayed in the bottom right corner of the portal page.

In some embodiments, a processor (not shown) associated with the user terminal 108 may generate the XML configuration file and store it on a memory (not shown) associated with the user terminal 108. Further, the portal server 104 may be communicably coupled to the user terminal 108 in order to access the configuration options stored in the XML configuration file. In other embodiments, the processor that generates the XML configuration file may be associated with the portal server 104.

The portal can be a web portal or an enterprise portal and is configured to aggregate data from different sources and display the aggregated data. In an embodiment, the portal is a web page that brings information together from diverse sources. Each piece of information from a specific source gets a dedicated display or presentation area on the portal as defined by an end-user or web designer. The dedicated display or presentation area is handled or managed by one or more portlets. Portlets are applications used by a data portal website to receive requests from a client terminal or a user terminal and return information. In some embodiments, the portal server 104 is the middleware between the application server 112 and the user terminal 108. The portal server 104 can run on top of the application server 112 or a cluster of application servers (not shown). The application server 112 or the cluster of application servers can host web applications related to data retrieval.

II. Portals and the Data Integration Portlet

A web portal is a specially designed web site that brings information together from diverse sources in a uniform way. Usually, each information source gets its dedicated area on the page for displaying information through a portlet. Further, the end-user can configure which ones to display. Variants of portals include mashups and intranet “dashboards” for executives and managers. The extent to which content is displayed may depend on the intended end-user and the intended purpose, as well as the diversity of the content. Very often design emphasis is on a certain “metaphor” for configuring and customizing the presentation of the content and the chosen implementation framework and/or code libraries. In addition, the role of the end-user in an organization may determine which content can be added to the portal or deleted from the portal configuration.

A portal may use a search engine application program interface (API) to permit end-users to search intranet content as opposed to extranet content by restricting which domains may be searched. Apart from this common search engines feature, web portals may offer other services such as e-mail, news, stock quotes, information from databases and even entertainment content. Portals provide a way for enterprises and organizations to provide a consistent look and feel with access control and procedures for multiple applications and databases, which otherwise would have been different web entities at various uniform resource locators (URL). The features available may be restricted by whether access is by an authorized and authenticated end-user (employee member) or an anonymous site visitor.

Portal servers provide a central platform for accessing web content and resources (data, docs, apps, integrations, alerts, etc.). A core feature of a portal is to provide a central URL that permits an end-user to have a custom web experience based upon the end-users' login identity. This functionality is termed role-based content delivery, or RBCD, and is a main focus for portals.

Websites based on Role-based Content Delivery (RBCD) allow an enterprise to develop a central web platform. Enterprises can then advertise a single website, and thereby increase the usage of the entire enterprise's resources as the central portal can integrate or guide end-users to other resources. RBCD has allowed administrators to build portal pages for different end-user types to customize the end-user experience based on an end-user's “formal identity,” such as a salesperson, engineer or manager.

Given that portal pages can include both applications (portlets and widgets) and web content, many portals have begun supporting integration to an external web content management system (WCMS) allowing content to be created or managed in a WCMS that appears in a portal page. This two-step process of adding content prompted some other portals to create an embedded WCMS.

Information technology systems involving portals, additionally, have begun to focus on end-users, allowing such end-users to interact with the system. End-users are often allowed to create their own pages or sites, to add collaboration apps to those pages and to define end-user access to those pages. Many portals also enable power end-users to have added features, such as web forms, workflows, dynamic lists and polls.

This focus on enabling the end-user, combined with RBCD, allows a central site to enable both the formal organizational structure as well as the informal organizational structure (a.k.a., social collaboration) and is a major difference between portals and many WCMS systems.

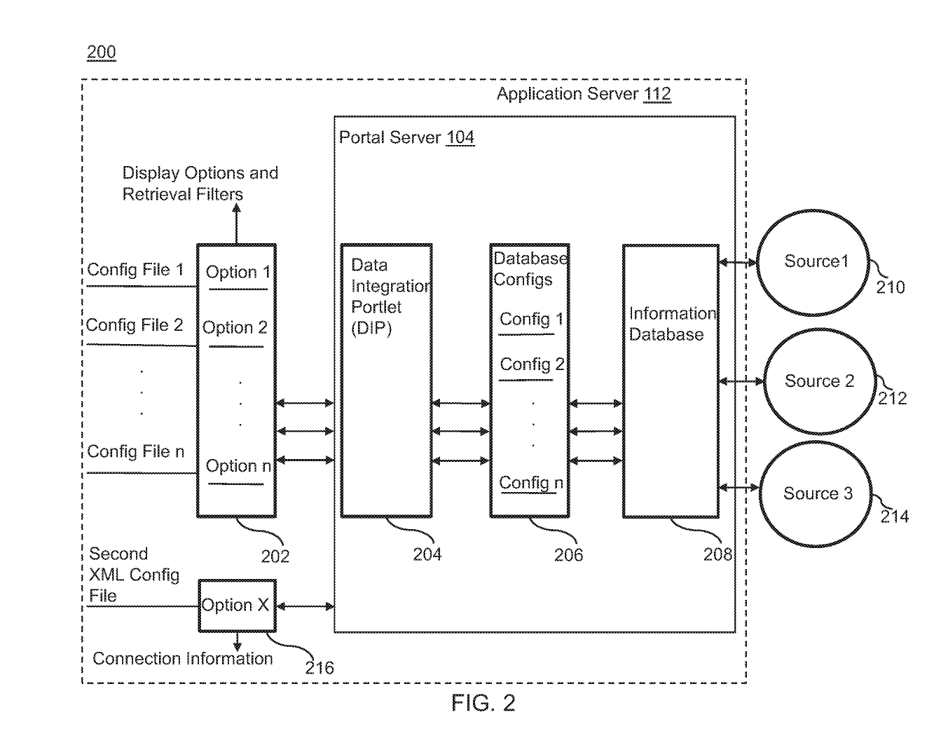

FIG. 2 illustrates a system 200 including a Data Integration Portlet (DIP) 204 that is installed and located on the portal server 104. As illustrated in FIG. 2, the user terminal 108 can create one or more first configuration files 202 (labelled as 1-N in FIG. 2) which can dictate certain display options. For example, each of the first configuration files can correspond to a specific end-user's desired data feeds and/or display options (e.g., configuration file 1 for John, configuration file 2 for Heather, and so forth). Alternatively, each of the first configuration files can correspond to different topics of interest, such as weather forecasts around a country (configuration file 1), political news (configuration file 2), etc. Each of the first configuration files can also set the display options that can control a display of data on the portal page. Each of the first configuration files can also lead to the generation of a second XML configuration file 216. The second XML configuration file 216 is a configuration file which can contain connection information that enables the connection to an information database 208 and data sources 210, 212 and/or 214 through the DIP 204. In some embodiments, each of the first XML configuration files may be associated one or more second XML configuration files.

Each of the first XML configuration files 202 can include a set of display options and a set of data retrieval filters in accordance with the user-defined data source query. The second XML configuration file 216 can include connection information in accordance with the user-defined data source query. In some embodiments, each of the first XML configuration files 202 and the second XML configuration file 216 may be stored on a memory which includes, but is not limited to, a cloud storage on the internet, a network storage device and the like. Further, the XML configuration files can also be stored in a memory local to the user terminal 108 or can be uploaded by an end-user from a removable memory device communicably coupled to the user terminal 108. The removable memory can be a flash memory, a floppy disk drive, an optical disc, and so forth. Alternately, the first and second XML configuration file may be stored on the portal server 104.

The user terminal 108 can create queries based on the data to be retrieved. Each query can correspond to one or more configuration files. The queries include, but are not limited to, data retrieval filters, display options and connection information. The configuration file information includes connection information, display options and data retrieval filters. Connection information includes, but is not limited to, IP addresses, subnet masks, domain name server addresses, host name and suffix, execution parameters, and system information pertaining to the user terminal 108 and/or the portal server 104. Display options include, but are not limited to, at least one of a tabular layout, a chart layout, a news layout, a form layout, and a bullet layout. The data retrieval filters include one or more identities indicative of a data source illustrated in FIG. 2, as the data source 210, the data source 212 and/or the data source 214.

In some embodiments, the portal server 104 can include a non-transitory computer readable medium that is configured to access data from the data source 210, the data source 212 and/or the data source 214. The non-transitory computer readable medium may be a set of instructions executable by the portal server 104 to carry out various operations including, but not limited to, accessing and retrieving data, storing data, generating portlets and displaying data through the portlets. In some embodiments, the non-transitory computer readable medium can be configured by the portal server 104 to carry out various operations. Further, configuring the non-transitory computer readable medium may include executing the instructions stored therein.

The Data Integration Portlet (DIP) 204 is installed on the portal server 104. Each of the first XML configuration files 202 and the second XML configuration file 216 provide connection information, user-defined display options and data retrieval filters to the portal server 104 using the DIP 204. In some embodiments, the user-defined display options and data retrieval filters form a user-defined data source query. Each of the first XML configuration files 202 containing the user-defined data source query and the second XML configuration file 216 with the connection information is extracted to a configuration file database 206. The portal server 104, through the DIP 204, further uses the data source query defined by the user terminal 108 to extract data from multiple tables within an information database 208. In some embodiments, the information database 208 may be a relational database and/or an object-relational database. The information database 208 organizes data into one or more tables of columns and rows with a key identifying a row and/or column in each table. The keys for each row and/or column are used to define logical connections (called relationships) among the tables. Based on the user-defined queries, the data residing in the tables are manipulated such that the data is presented at the user terminal 108 in a legible format. The data stored in multiple tables on the information database 208 is retrieved from any or a combination of the data source 210, the data source 212 and/or the data source 214. In some embodiments, the data may be retrieved, using the DIP 204, in real time as per the data source query received at the portal server 104. In some other embodiments, the data may have been retrieved before a data source query is received at the portal server 104.

In some embodiments, the configuration file database 206 may be a relational database that contains the user-defined queries retrieved from the XML configuration files. The data retrieval filters and the display options are stored in one or more tables with a key identifying a row and/or column in each table. The keys are used to define logical connections or relationships between multiple rows and/or columns of the tables.

The portal server 104 includes a set of software applications that enables generation of portals. The portal server 104 further acts as a single access point for the user terminal 108 to retrieve data from the data source 210, the data source 212 and/or the data source 214. The portal server 104 can generate and configure a plurality of portlets based on the first and second XML configuration file, the plurality of portlets communicating with the application server 112. In some embodiments, the plurality of portlets may be on the portal server 104. Further, the application server 112 is communicably coupled to the any one or a combination of the data sources 210, 212 and/or 214. Data extracted by the portal server 104 is stored in the information database 208 in a predefined format. The predefined format corresponds to the data being organized in multiple tables with a key identifying a row and/or column in each table in the data. The keys provide logical connections between the rows and columns of one table and the rows and columns of another table

The portal server 104 can transform the data retrieved from the data source 210, the data source 212 and/or the data source 214 in accordance with the predefined format and populate the tables of the information database 208 with the data retrieved from the data sources 210, 212 and/or 214. The portal server 104 can implement various algorithms to convert or transform the retrieved data including, but not limited to, including statistical methods, probabilistic methods, and so forth. In case any data does not include an entry corresponding to any of the tables, the tables are left blank. Therefore, the information database 208 may allow standardization of data from different data sources, and enable quick display of the stored data in accordance with the predefined format, and the set of display options.

In an embodiment, the user queries, the display options and the data retrieval filters may be obtained via a user interface which will be described in detail hereinafter.

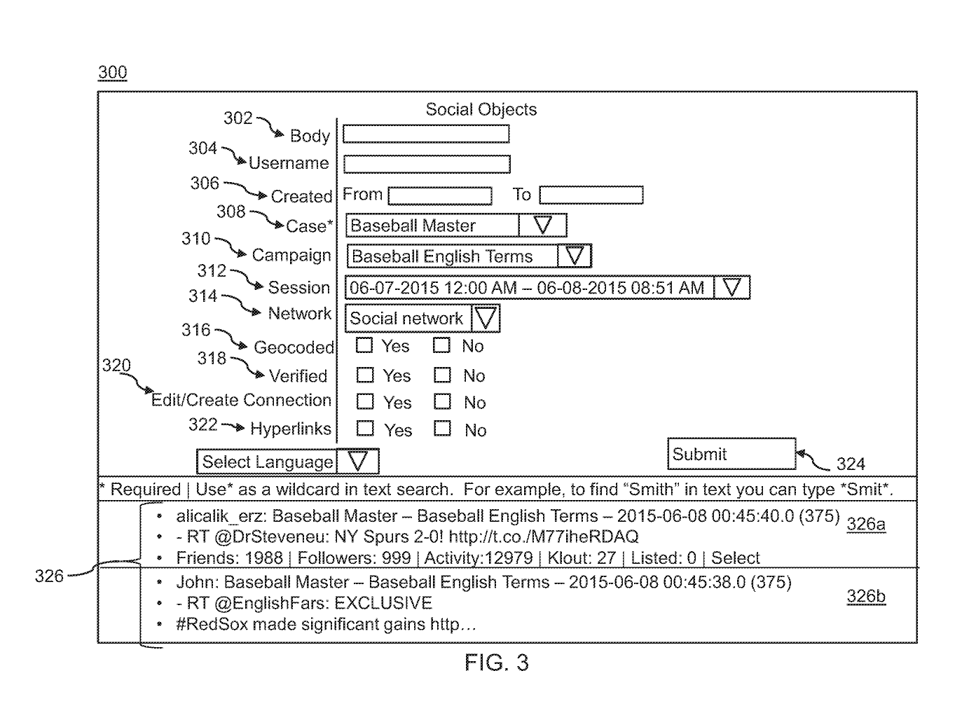

FIG. 3 illustrates an exemplary embodiment of a user interface 300 presented on the user terminal 108. The user interface 300 can be communicably coupled to the portal server 104 and the application server 112 shown in FIG. 2. The user interface 108 can be part of a web portal or communicate with the web portal that is displayed on the user terminal 108. Further, the web portal may be located on and configured by the portal server 104. The user interface 300 includes fields for various query parameters. The fields include, but are not limited to, a body field 302, a username field 304, query creation dates field 306, a query title or case field 308, a language filter field 310, date/time stamp details field 312, a data source field 314, location filters field 316, authenticate filters field 318, a connection information field 320 and a field 322 for hyperlink filters. The connection information field 320 can enable additional options to provide connection information that connects the user terminal 108 to the information database 208 and/or the data sources 210, 212, 214. Results are displayed according to choices made in the aforementioned fields at a results field 326. The submit button 324 is utilized to submit the information provided at the fields 302 to 320 to compile the data source query. The portal server 104 can utilize the various options corresponding to the fields 302 to 320 to generate a first XML configuration file. The first XML configuration file is one of the XML configurations files 202, as shown in FIG. 2.

If the “Yes” box for the connection information field 320 is checked by the end-user, clicking the submit button 324 can lead to a dialog window or an additional form on which details pertaining to the connection information is given by an end-user leading to the generation of the second XML configuration file 216. The details received on the dialog box or the additional form can include IP addresses, subnet masks, domain name server addresses, host name and suffix, execution parameters, and so forth.

In case the “No” box for the connection information field 320 is checked by the end-user, the connection information field 320, the portal server 104 can generate the second XML configuration file 216 based on one or more options specified in the first XML configuration file. The one or more options, based on which the second XML configuration file include a data source identifier or name provided at the fields 314 to 318. In some embodiments, the portal server 104 may extract a data source identifier or name from the data source field 314 and then use preset connection information corresponding to the data source identifier in order to generate the second XML configuration file 216. For example, if the data source identifier corresponds to the data source 212, the portal server 104 may use preset connection information corresponding to the data source 212. The preset connection information can include IP addresses, subnet masks, domain name server addresses, host name and suffix, execution parameters, and so forth.

In some embodiments, one or more connection portlets may be generated in accordance with the second XML configuration file and a connection is created between the user terminal 108, the portal server 104, the application server 112 and any one or a combination of the data sources 210, 212 and/or 214.

In some embodiments, the results field 326 is associated with one or more data portlets. Each of the fields 302 to 324 and the results field 326 correspond to one or more data portlets generated by the portal server 104. Further, the results are displayed through a first data portlet 326a and a second data portlet 326b. The first data portlet 326a and the second data portlet 326b may be generated by the portal server 104.

Choices made on the user interface 300 form the data source query and is embedded into a first Extensible Markup language (XML) configuration file stored on the user terminal 108. An example of the information stored in the first XML configuration file is shown below:

```
<QuerySettings>
  <DatabaseVendor>PostgreSQL</DatabaseVendor>
  <Connection>
    <ConnectionID>2</ConnectionID>
  </Connection>
  <QueryString>SELECT verifiedimg, verifiedyn, username, displayname,
authorkloutscore, useractivitycount, friends,
followers, listedcount, favoritescount, retweetcount,
generator, verified, profileimgurl, network, created, createdyear,
createdmonth, createdday, body, isre, origobjsrcid, objectsrcunid, origauthor, sourceid,
hashtags,
languages, expandedurls, verb, usermentionsnames, usermentionsids, mediaurls, Ion,
lat, headline,
tagline, createdby, objectcreateddate, geocoordinates,
linktoobject, resultid, Geocoded, globe, resultid, id, userbiolocation, mediatype,
usermentionsscreennames, actorid, verified, userbiolocation, sentiment_tag,
sentiment_score, user_sentiment_votes,
user_sentiment_average, user_sentiment_mode, user_sentiment_median, mediayn
, tsv_body
```

The above is a snippet from an exemplary XML configuration file used in accordance with the disclosed subject matter. In some embodiments, some portions of the code may be attributed to any of the first XML configuration files 202 and other portions of the code may be attributed to the second XML configuration file 216. For example, the first XML configuration file may utilize code referencing the “Querystring” tag, as shown in the snippet above. The second XML configuration 216 may utilize code referencing the “Connection” tag.

Each of the first XML configuration files 202 uses a single data source query extracted from the input through the user interface 300 to retrieve data from multiple tables within the information database 208. The first XML configuration file is used for the processing, definition and presentation of data on the user interface 300. Through the first XML configuration file, code is specified for formatting various layouts and styles pertaining to presentation of data. The first XML configuration file, as seen in the sample code above, includes the user-defined query, that further includes a set of display options and a set of data retrieval filters. In the above snippet, the “Querystring” tag provides the multiple fields shown in FIG. 3 as the fields 302 to 322.

The second XML configuration file 216 may use similar code as the sample code above and provides connection information to enable a connection between the user terminal 108 and the information database 208 (in the current example the information database 208 being an object-relational database provided by PostgreSQL®).

In various embodiments, the database connection details or connection information, such as those referenced in the “Connection” tag of the XML code above, can be specified in the second XML configuration file.

Each of the first XML configuration files 202 and the second XML configuration file 216 further act as tools to transport the data source query information from the user terminal 108 to the configuration file database 206 and the information database 208. Subsequently, based on the data source query, the portal server 104 extracts the data corresponding to the retrieval filters specified at the fields 302 to 322 from the data source specified at the data source field 314. The data is extracted in a predefined format at the information database 208. Subsequently, the extracted data is presented based on the display options specified in the user-defined query through the portlets corresponding to the results field 326 as shown in FIG. 3.

In order for a single query, such as that shown in the XML sample above, to retrieve data from multiple sources, the data would need to exist in any of the data source 210, the data source 212 and/or the data source 214 and in the information database 208 specified in the query.

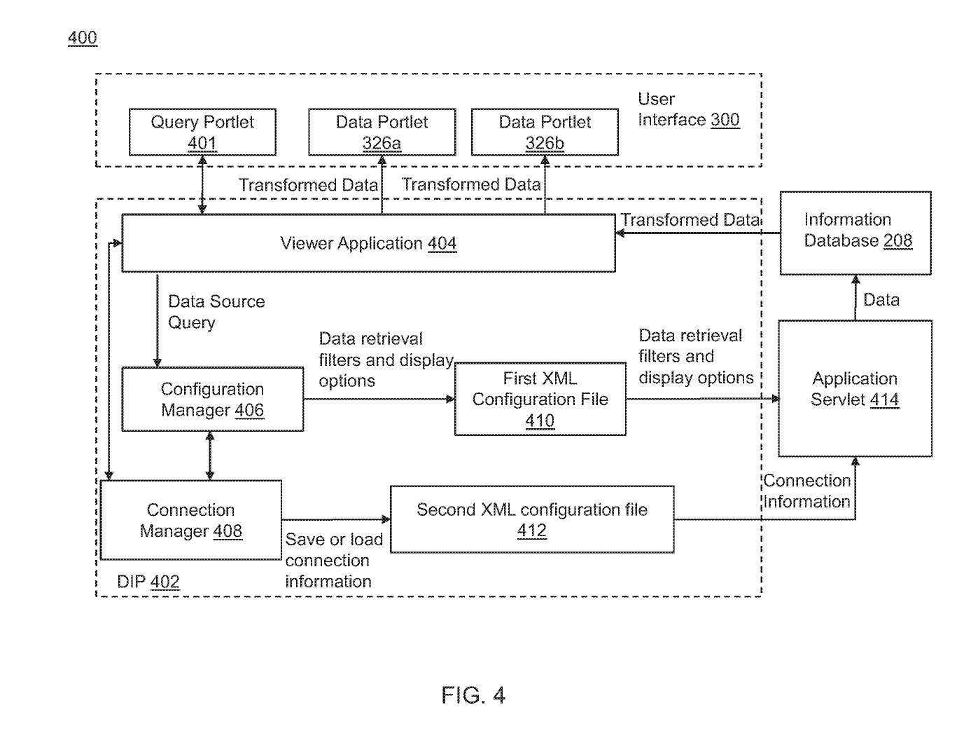

FIG. 4 is a schematic of a system 400 including a DIP 402 in accordance with the disclosed subject matter. All configurations and settings for the DIP 402 are stored in a first XML configuration file 410 and a second XML configuration file 412. Referring to FIGS. 2, 3 and 4, the DIP 402 includes a viewer application 404 communicably coupled to the user interface 300. In some embodiments, the user interface 300 can be configured by the portal server 104 via the viewer application 404. The data source query is compiled by a viewer application 404, by utilizing the information provided by an end-user at the fields 302 to 322 on the user interface 300. The fields 302 to 322 can be associated with a query portlet 401 to transfer the information from the end-user to the viewer application 404. The query portlet 401 can be generated and configured by the portal server 104, and can transmit the data source query to the viewer application 404. Further, the viewer application 404 in conjunction with the query portlet 401 provides the fields 302 to 320 in the user interface 300 displayed on the user terminal 108.

In some embodiments, the viewer application 404 complies the data source query from information provided at fields 302 to 320. The viewer application 404 also facilitates the display of retrieved data at the data portlets 326a and 326b. In some embodiments, the viewer application 404 may be part of the portal configured by the portal server 104. In some other embodiments, the viewer application may be a specific application stored in the local memory of user terminal 108 or stored on a removable memory communicatively coupled to the user terminal 108.

The DIP 402 further includes a configuration manager 406 and a connection manager 408. The configuration manager 406 receives the data source query from the viewer application 404 and generates a first XML configuration file 410. The configuration manager 406, further embeds the data retrieval filters and the display options for a specific data source query in a first XML configuration file 410. Further, one or more sets of keywords provided at the body field 302 is also embedded in the first XML configuration file. Specifically, the configuration manager 406 can fill the options under the various tags, such as the “Querystring” tag featured in the sample code above, in the first XML configuration file 410. Other tags used by the configuration manager 406 may be similar to the XML code described above. In some embodiments, the configuration manager 406 generates the first XML configuration file 410 with the data retrieval filters and the display options embedded.

The DIP 402 is connected to the information database 208, and to any one or a combination of the data sources 210, 212 and/or 214 via an application servlet 414. The application servlet 414 can be located on and configured by the application server 112. Further, the application servlet 414 on the application server 112 may be communicably coupled to multiple portlets of the DIP 402 including the configuration manager 406, the connection manager 408, and the viewer application 404. In an embodiment, the application servlet 414 may include a set of instructions that can be executed by the application server 112 to carry out various operations. The application servlet 414 further facilitates visualization and usage of the data through the user interface 300, without any coding.

Based on options provided at the connection information field 320, end-users may enter connection information through a form-based user interface generated by the viewer application 404, so as to connect to the information database 208 and the application servlet 414. In some embodiments, a system administrator or a privileged end-user can create the connection, and subsequently other end-users can leverage the connection to configure the DIP 204 without needing to know any of the connection details. The connection may be made by entering a Java Database connection (JDBC) string and authentication information into a form, naming the connection and saving it. The connection information can also include IP addresses, subnet masks, domain name server addresses, host name and suffix, execution parameters, and so forth.

Alternately, based on the options provided at the connection information field 320, the connection manager 408 can generate the second XML configuration file 412 with preset connection information. The preset connection information can correspond to a data source identifier or name identified among the options specified in the first XML configuration file 410. The data source identifier or name may be originally provided at the data source field 314. The connection manager 408 may retrieve relevant connection information from the data source query directly from the viewer application 404 or from the configuration manager 406. All DIP Connection parameters are stored in the second XML configuration file 412. The first XML configuration file 410 and the second XML configuration file 412 can be stored on the configuration file database 206 (shown in FIG. 2).

In some embodiments, the viewer application 404, the configuration manager 406, and the connection manager 408 may be portlets located on and configured by the portal server 104. Further, the DIP 402 can include at least two of the viewer application 404, the configuration manager 406 and the connection manager 408. For example, the DIP 402 may not include a separate connection manager 408 and the configuration manager 406 may perform the functions of the connection manager 408. Therefore, the portal server 104 executes various operations of the DIP 402 through various portlets including the viewer application 404, the configuration manager 406, and the connection manager 408.

The connection manager 408 enables the connection to any or a combination of the data sources 210, 212 and/or 214 in accordance with the connection information in the second XML configuration file 412 via the application servlet 414. Connection information specified in the second XML configuration file 412 is accessed by the connection manager 408 and the application servlet 414. The application servlet 414 then makes a query to the data sources 210, 212 and/or 214 and accordingly retrieves a set of data based on the data retrieval filters. The retrieved data is stored on the information database 208 in a predefined format. The portal server 104 or the application servlet 414 can transform the data retrieved from the data source 210, the data source 212 and/or the data source 214 in accordance with the predefined format and populate the tables of the information database 208 with the data retrieved from the data sources 210, 212 and/or 214. The portal server 104 or the application servlet 414 can implement various algorithms to convert or transform the retrieved data including, but not limited to, including statistical methods, probabilistic methods, and so forth. In case, any data does not include an entry corresponding to any of the tables, the tables are left blank. Therefore, the information database 208 may allow standardization of data from different data sources, and enable quick display of the stored data in accordance with the predefined format and the set of display options.

III. Exemplary Embodiments

Referring to FIGS. 1A to 4, in an exemplary scenario, the fields 302 to 324 in the user interface 300 are populated by an end-user such that options relating to the connection information, the set of data retrieval filters and the set of display options are specified. In accordance with the sample XML code above, the populated fields 302 to 324 enable selections of the query strings such that a data source query is created and embedded into the first XML configuration file 410. The query portlet 401 enables the transmission of information provided at the fields 302 to 322 to the viewer application 404. The viewer application 404 compiles a data source query based on the information received and transmits the data source query to the configuration manager 406. The configuration manager 406 generates the first XML configuration file 410 containing the set of data retrieval filters and the set of display options. In accordance with options specified in the first XML configuration file 410, the connection manager 408 can generate the second XML configuration based either on preset connection information corresponding to the name or identifier provided at the data source field 314, or based on information provided by the end-user in a form-based user interface through the query portlet 401.

Using the DIP 204 that is installed on the portal server 104, the data source query, along with other configuration information contained in the first XML configuration file 410 and the connection information contained in the second XML configuration file 412, is transmitted to the configuration file database 206.

The application servlet 414 enables the connection to any or a combination of the data sources 210, 212 and/or 214 in accordance with the display options and the data retrieval filters in the first XML configuration file 410, and the connection information in the second XML configuration file 412. The application servlet 414 then makes the query to the data sources 210, 212 and/or 214 and accordingly retrieves a set of data. The retrieved data is stored on the information database 208 in the predefined format. The predefined format includes the retrieved data being stored in multiple tables with each row and/or column of each table being identified by a key. The keys are used to establish logical connections between rows and columns of one table in the information database 208 with the rows and columns of another table in the information database 208.

The information database 208 stores data retrieved from the data source 210, the remote data source 212 and/or the remote data source 214 in accordance with the first XML configuration file 410 and the second XML configuration file 412. The data may be retrieved prior to the data source query and the connection information being received at the configuration file database 206. In alternative embodiments, the data may be retrieved upon receiving the user-defined query and the configuration information.

Based on the data source query stored in the tables of the configuration file database 206, retrieved data, corresponding to any one or a combination of the data source 210, the data source 212 and the data source 214, is extracted from the tables of the information database 208 and presented on the user interface 300 (as shown in FIG. 3) at the data portlets corresponding to the results field 326. In an embodiment, the viewer application 404 in conjunction with the application servlet 414 can retrieve a set of data based on the data source query, and display the set of data through the first and second data portlets 326a, 326b on the user interface 300 according to the set of display options. The display options can include a display format (e.g., tabular format), a display position on the user interface 300, font of the text, color of the text, one of a tabular layout, a chart layout, a news layout, a form layout, and a bullet layout, and so forth. The first and second data portlets 326a, 326b can be generated and configured by the viewer application 404.

Some embodiments are directed to the system 100 that facilitates exchange of a data between the data sources 102 and the user terminal 108, using one or more portlets installed on a portal server 104. A first XML configuration file 410 containing a data source query is generated at the user terminal 108. The data source query includes a set of data retrieval filters and a set of display options. A second XML configuration file 412 is generated, the second XML configuration file 412 specifying the connection information enabling the connections between the user terminal 108, the information database 208 and the application servlet 414. The portal server 104 may retrieve and display data based on the set of data retrieval filters and the set of display options.

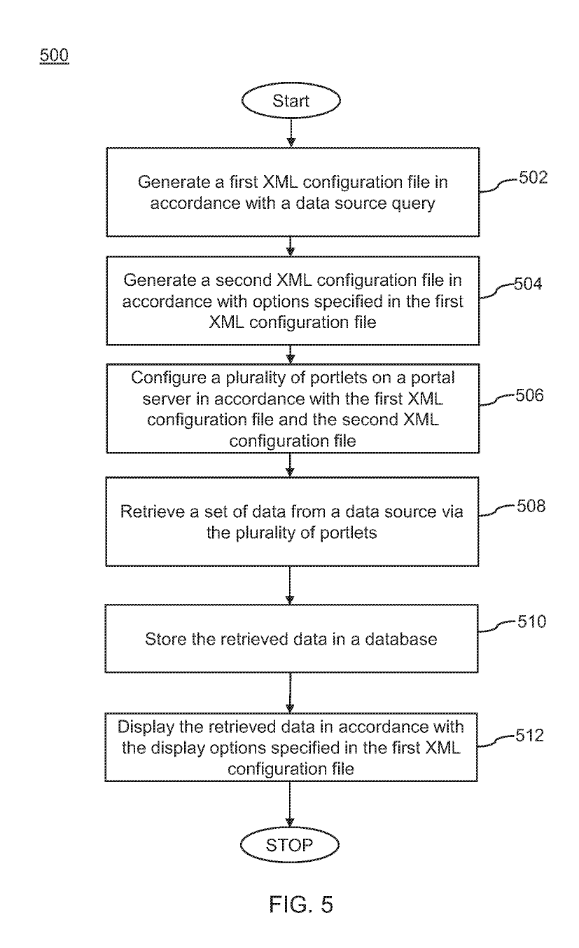

FIG. 5 illustrates a method 500 of retrieving data from one or more remote data source in accordance with the disclosed subject matter. This flowchart is merely provided for exemplary purposes, and embodiments are intended to include or otherwise cover any methods or procedures for data retrieval.

In accordance with the flowchart of FIG. 5, at step 502, the configuration manager 406 generates the first XML configuration file 410 in accordance with the data source query received from the user terminal 108 and compiles the information provided at fields 302 to 320. In some embodiments, a processor (not shown) associated with the user terminal 108 generates the first XML configuration file 410 and stores it on a memory (not shown) local to the user terminal 108. The data source may be selected through choices on the form-based user interface 300 generated by the viewer application 404 and the choices are embedded into the first XML configuration file 410 stored on the user terminal 108. The choices include a set of display options, a set of data retrieval filters and an option to further provide connection information.

At step 504, based on the option to further provide connection information, a dialog box or a new portal page generated by the viewer application 404 is shown at the user terminal 108 where the end-user provides the connection information. The connection information can be specified in the first XML configuration file 410. Based on the connection information specified in the first XML configuration file 410, a second XML configuration file 412 is generated by the connection manager 408. The portal server 104 connects to the data sources 210, 212 and/or 214 via the connection manager 408. The connection manager 408 accesses the connection information specified in the second XML configuration file 412 to connect to the data source.

At step 506, multiple portlets are configured by the portal server 104 to transmit the data source query and to enable the connection between the user terminal 108, the information database 208, the application servlet 414 and the data sources 210, 212 and/or 214. The configured portlets further comprise at least two of the viewer application 404, the configuration manager 406 and the connection manager 408. The portal server 104 may configure the viewer application 404, configuration manager 406 and the connection manager 408 based on the options specified in the first and second XML configuration file 410 and 412. In some embodiments, the connection manager 408 may generate one or more connection portlets (not shown) in accordance with the second XML configuration file 412 and a connection is created between the user terminal 108, the portal server 104 and any or a combination of the data sources 210, 212 and/or 214.

At step 508, data is retrieved from any or a combination of the data sources 210, 212 and/or 214 by the portal server 104 in conjunction with the application servlet 414 in accordance with parameters specified in both the first and second XML configuration files 410 and 412. The parameters can include the set of data retrieval filters, the set of display options and the connection information. At step 510, the portal server 104 in conjunction with the application servlet 414 can store the retrieved data in tables of the information database 208 in accordance with the predefined format. The retrieved data may be in a raw format and is accordingly transformed to the predefined format. The predefined format is a presentation format that may be implemented in accordance with the display options made available through the first XML configuration file 410. Such a format facilitates data retrieval processes in a customized presentation as defined by the user terminal 108.

At step 512, the retrieved information is displayed accordingly. Data is retrieved from one or more data sources in accordance with both the first XML configuration file 410 and the second XML configuration file 412. Further, the retrieved data is displayed at the data portlets 326a and 326b in accordance with the first and second display options in the first XML configuration file 410 and the second XML configuration file 412, respectively.

In various embodiments, one or more of the steps 502 to 512 may be implemented by the portal server 104 as per instructions provided in the non-transitory computer readable medium.

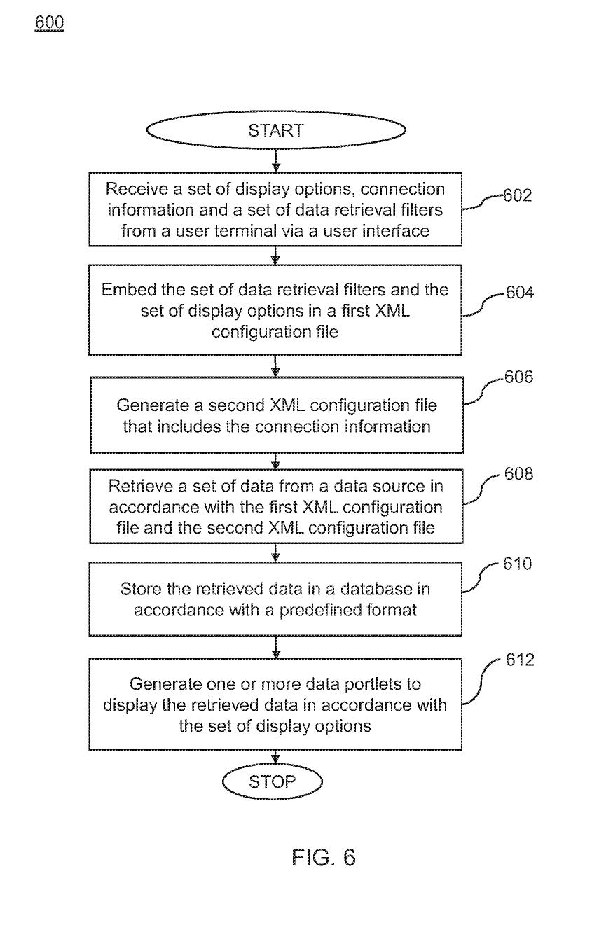

FIG. 6 is a flowchart of a method 600 for retrieving data from one or more data sources in accordance with the disclosed subject matter. Through the form-based user interface 300, a data source query is received at step 602. The data source query includes a set of data retrieval filters and a set of display options. The connection information may be provided by an end-user upon enabling an option to provide connection at the connection information field 320. In some embodiments, the connection information may be provided in a separate portal page with a form-based user interface generated by the viewer application 404. Alternately, the connection information may be compiled by the viewer application 404 from a data source identifier or name provided at the data source field 314 on the user interface 300.

At step 604, the data retrieval filters and display options are embedded in the first XML configuration file 410, the first XML configuration file being generated by the configuration manager 406. The data retrieval filters include one or more identities of the data sources 102 and one or more sets of keywords. In some embodiments, the first XML configuration file can be stored on a memory local to the user terminal 108.

At step 606, the connection manager 408 can generate the second XML configuration file 412 in accordance with one or more options specified in the first XML configuration file. The one or more options, based on which the second XML configuration file is generated, can include a data source identifier or name provided at the fields 302 to 318. In some embodiments, the connection manager 408 may extract a data source identifier or name from the data source field 314 and then use preset connection information corresponding to the data source identifier in order to generate the second XML configuration file 412.

The configuration file information further includes connection information which can include any one or a combination of IP addresses, subnet masks, domain name server addresses, host name and suffix, execution parameters, and system information pertaining to the user terminal 108 and/or the portal server 104. In some embodiments, multiple portlets are configured by the portal server 104 to transmit the data source query and to enabling the connection between the user terminal 108, the portal server 104, the information database 208, the application servlet 414 and the data sources 210, 212 and/or 214. Each of the multiple portlets can include at least two of the viewer application 404, the configuration manager 406, and the connection manager 408. In some embodiments, the connection manager 408 can also generate one or more connection portlets in accordance with the second XML configuration file 412. A connection is created between the user terminal 108, the portal server 104, the information database 208, the application servlet 414 and any or a combination of the data sources 210, 212 and/or 214 using the connection manager 408. At step 608, data is retrieved in accordance with the set of data retrieval filters specified in the first XML configuration file 410. At step 610, the retrieved data is stored in a predefined format in the information database 208. The predefined format includes all of the display options made available to the user terminal 108 in accordance with the first XML configuration file 410 and the second XML configuration file 412.

Further, at step 612, the retrieved data is displayed at the data portlet 326a and the data portlet 326b on the viewer application 404 in accordance with the set of display options, the set of display options and the predefined format. In some other embodiments, the generated portlet leads to a new web page showing the retrieved data. The data portlets 326a and 326b may be generated by the portal server 104.

In various embodiments, one or more of the steps 602 to 612 may be implemented by the portal server 104 as per instructions provided in the non-transitory computer readable medium.

IV. Other Exemplary Embodiments

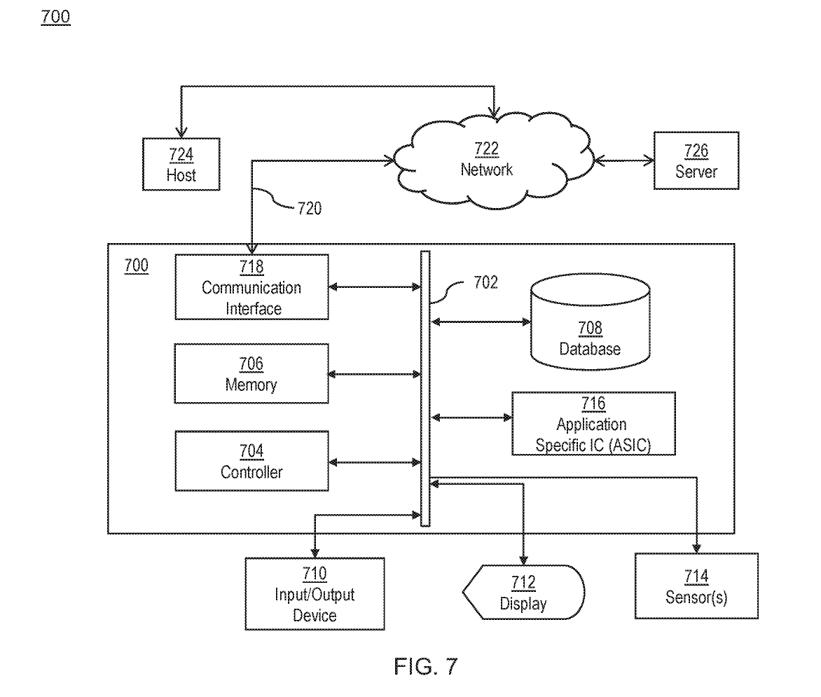

FIG. 7 illustrates a computer system 700 upon which the operation of the user terminal 108, the DIP 402, the configuration file database 206, the information database 208, the configuration manager 406, the connection manager 408, the application servlet 414 and the portal server 104 may be implemented. Although, the computer system 700 is depicted with respect to a particular device or equipment, it is contemplated that other devices or equipment (e.g., network elements, servers, etc.) within FIG. 7 can deploy the illustrated hardware and components of system. The computer system 700 is programmed (e.g., via computer program code or instructions) to retrieve data from the data sources 102 described herein and includes a communication mechanism such as a bus 702 for passing information between other internal and external components of the computer system 700. Information (also called data) is represented as a physical expression of a measurable phenomenon, typically electric voltages, but including, in other embodiments, such phenomena as magnetic, electromagnetic (light, fields, etc), pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. The computer system 700, or a portion thereof, constitutes a means for performing one or more steps retrieving data from one or more data sources 102.

A bus 702 includes one or more parallel conductors of information so that information is transferred quickly among devices coupled to the bus 702. A processor 704 for processing information are coupled with the bus 702.

The processor 704 performs a set of operations on information as specified by an end-user. Further, the processor 704 can generate the first XML configuration file 410 and the second XML configuration file 412. The computer program code is a set of instructions or statements providing instructions for the operation of the processor 704 and/or the computer system 700 to perform specified functions. The code, for example, may be written in a computer programming language that is compiled into a native instruction set of the processor 704. The code may also be written directly using the native instruction set (e.g., machine language). The set of operations include bringing information in from the bus 702 and placing information on the bus 702. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 704, such as a sequence of operation codes, constitute processor instructions, also called computer system instructions or, simply, computer instructions. The processor 704 may be implemented as mechanical, electrical, magnetic, optical, chemical, or quantum components, among others, alone or in combination.

The computer system 700 also includes a memory 706 coupled to the bus 702. The memory 706, such as a Random Access Memory (RAM) or any other dynamic storage device, stores information including processor instructions for storing information and instructions to be executed by the processor 704. The dynamic memory 706 allows information stored therein to be changed by the computer system 700. RAM allows a unit of information stored at a location called a memory address to be stored and retrieved independently of information at neighboring addresses. The memory 706 is also used by the processor 704 to store temporary values during execution of processor instructions. The computer system 700 also includes a Read Only Memory (ROM) or any other static storage device coupled to the bus 702 for storing static information, including instructions, that is not changed by the computer system 700. Some memory is composed of volatile storage that loses the information stored thereon when power is lost. Also coupled to the bus 702 is a non-volatile (persistent) storage device 708, such as a magnetic disk, a solid state disk, optical disk or flash card, for storing information, including instructions, that persists even when the computer system 700 is turned off or otherwise loses power.

Information, including instructions for inspecting the XML data source query files is provided to the bus 702 for use by the controller 704 from an external input/output device 710. From an input perspective, the input/output device could include one or more elements such as a keyboard containing alphanumeric keys operated by a human user, a mouse, trackball, microphone, an Infrared (IR) remote control, a joystick, a game pad, a stylus pen, a touch screen, or any other of an input/output device. These devices can be capable of controlling a position of a small cursor image presented on the display 712 and issuing commands associated with graphical elements presented on the display 712.

From an output perspective, the input/output device 710 could include a Cathode Ray Tube (CRT), a Liquid Crystal Display (LCD), a Light Emitting Diode (LED) display, an organic LED (OLED) display, an active matrix display, an Electrophoretic Display (EPD), a plasma screen, or a printer for presenting text or images. Additionally, a separate display 712 may also include any of the previously mentioned devices or any other devices capable of visually, audibly, or even by means of touch, scent, etc. to provide output data to a user. Further, the display 712 may be a touch enabled display such as capacitive or resistive screen. In some embodiments, for example, in embodiments in which the computer system 700 performs all functions automatically without human input, one or more of the external input device 710, and the display 712 may be omitted.

Sensors 714 may be provided as components of the input/output device 710, or may be provided as independent components to the system 700. The sensor(s) 714 may detect conditions in its vicinity and transform those detections into physical expressions compatible with the measurable phenomenon used to represent information in the computer system 700 such as capturing, recording and causing to store one or more still and/or moving images (e.g., videos, movies, etc.) which also may comprise audio recordings. Sensors 714 may also detect elements such as motion, temperature, imagery or video, etc.

Other external devices can also be coupled to the bus 702 such as an Application Specific IC (ASIC) device 716. In the illustrated embodiment, special purpose hardware such as the ASIC 716 might serve as special purpose hardware configured to perform operations not performed by the controller 704 quickly enough for various purposes. Examples of ASICs include graphics accelerator cards for generating images for the display 712, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 700 also includes one or more instances of a communication interface 718 coupled to the bus 702. The communication interface 718 provides a one-way or two-way communication coupling to a variety of external devices that operate with their own processors, such as printers, scanners and external disks. In general, the coupling is with a network link 720 that is connected to a local network 722 to which a variety of external devices with their own processors are connected. For example, the communication interface 718 may be a parallel port or a serial port or a Universal Serial Bus (USB) port on a personal computer. In some embodiments, the communication interface 718 is an Integrated Services Digital Network (ISDN) card, a Digital Subscriber Line (DSL) card, or a telephone modem that provides an information communication connection to a corresponding type of a telephone line. In some embodiments, the communication interface 718 is a cable modem that converts signals on the bus 702 into signals for a communication connection over a coaxial cable or into optical signals for a communication connection over a fiber optic cable. As another example, the communication interface 718 may be a Local Area Network (LAN) card to provide a data communication connection to a compatible LAN, such as Ethernet™ or an Asynchronous Transfer Mode (ATM) network. In one embodiment, wireless links may also be implemented. For wireless links, the communication interface 718 sends or receives or both sends and receives electrical, acoustic or electromagnetic signals, including infrared and optical signals that carry information streams, such as digital data. For example, in wireless handheld devices, such as mobile telephones like cell phones, the communication interface 718 includes a radio band electromagnetic transmitter and receiver called a radio transceiver. In certain embodiments, the communication interface 718 enables connection to the communication network 106 for inspecting the user queries in the XML configuration files. Further, the communication interface 718 can include peripheral interface devices, such as a thunderbolt interface, a Personal Computer Memory Card International Association (PCMCIA) interface, etc. Although a single communication interface 718 is depicted, multiple communication interfaces can also be employed.

The term “computer-readable medium” as used herein refers to any medium that participates in providing information to the processor 704, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as the storage device 708. Volatile media include, for example, the dynamic memory 706. Transmission media include, for example, twisted pair cables, coaxial cables, copper wire, fiber optic cables, and carrier waves that travel through space without wires or cables, such as acoustic waves, optical or electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a USB flash drive, a Blu-ray disk, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 716.

The network link 720 typically provides information communication using transmission media through one or more networks to other devices that use or process the information. For example, the network link 720 may provide a connection through the local network 722 to a host computer 724 or to ISP equipment operated by an Internet Service Provider (ISP).

A server 726, connected to the Internet, hosts a process that provides a service in response to information received over the Internet. For example, the server 726 hosts a process that provides information representing video data for presentation at the display 712. It is contemplated that the components of the computer system 700 can be deployed in various configurations within other computer systems, e.g., the host 724 and the server 726.

At least some embodiments of the invention are related to the use of the computer system 700 for implementing some or all of the techniques described herein. According to one embodiment of the invention, those techniques are performed by the computer system 700 in response to the processor 704 executing one or more sequences of one or more processor instructions contained in the memory 706. Such instructions, also called computer instructions, software and program code, may be read into the memory 706 from another computer-readable medium such as the storage device 708 or the network link 720. Execution of the sequences of instructions contained in the memory 706 causes the processor 704 to perform one or more of the method steps described herein. In alternative embodiments, hardware, such as the ASIC 716, may be used in place of or in combination with software to implement the invention. Thus, embodiments of the invention are not limited to any specific combination of hardware and software, unless otherwise explicitly stated herein.

Various forms of computer readable media may be involved in carrying one or more sequence of instructions or data or both to the processor 704 for execution. For example, instructions and data may initially be carried on a magnetic disk of a remote computer such as the host 724. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 720. An infrared detector serving as the communication interface 718 receives the instructions and data carried in the infrared signal and places information representing the instructions and data onto the bus 702. The bus 702 carries the information to the memory 706 from which the processor 704 retrieves and executes the instructions using some of the data sent with the instructions. The instructions and data received in the memory 706 may optionally be stored on the storage device 708, either before or after execution by the processor 704.

V. Alternative Embodiments

While certain embodiments of the invention are described above, and FIGS. 1A-7 disclose the best mode for practicing the various inventive aspects, it should be understood that the invention can be embodied and configured in many different ways without departing from the spirit and scope of the invention.

For example, embodiments are disclosed above in the context of retrieving data from one or more data sources based on user queries embedded in XML configuration files. However, embodiments are intended to include or otherwise cover any type of configuration file.

Embodiments as disclosed above allow retrieval of data from different data sources and display the data as per user-defined display options and data retrieval filters through a portal server and an associated portal. Embodiments of the present disclosure further enable the portal server to be a single point of access in data retrieval and display without using any additional resources or applications on an end-user terminal.

Embodiments, as disclosed above, are directed to a system that facilitates exchange of one or more sets of data between data sources and a user terminal, using one or more portlets installed on a portal server. The portal server generates a first XML configuration file containing data retrieval filters and display options based on a data source query received from the user terminal. The portal server can also generate a second XML configuration file containing connection information based on one or more options specified in the first XML configuration file. Therefore, an end user having no knowledge about the connection information can use the system for retrieving and displaying data.

In some embodiments, the first and second XML configuration files may be stored on a memory communicably coupled with a network, a removable memory communicably coupled with the user terminal or a memory local to the user terminal. The system also retrieves data from the data sources and displays the retrieved data through one or more portlets in accordance with the first and second XML configuration files.

Embodiments are also intended to cover storing retrieved data in any predefined format in a database associated with the portal server such that the data can be displayed through portlets generated by the portal server. The predefined format can be based on a type of data source and user-defined data fields provided in an XML configuration file.

Embodiments are also intended to cover any form building toolkit that allows creation of forms without coding for a portal page. The forms can be used to receive options from a user and display data.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary embodiments disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method for exchanging data between a user terminal and a data source, the method comprising:
generating a first XML configuration file in accordance with a data source query received from the user terminal;
generating a second XML configuration file in accordance with options specified in the first XML configuration file;
configuring a plurality of portlets on a portal server based on the first XML configuration file and the second XML configuration file;
retrieving a set of data from the data source via the plurality of portlets operating on the portal server, the plurality of portlets communicating with an application server, wherein the application server is communicably coupled to the data source;
storing the set of data in a database, and
displaying the set of data via one or more data portlets in accordance with the options specified in the first XML configuration file.

2. The method of claim 2, wherein the plurality of portlets further comprises at least two of a connection manager, a viewer application and a configuration manager.

3. The method of claim 2 further comprising:
generating the first XML configuration file by the configuration manager; and
generating the second XML configuration file by the connection manager.

4. The method of claim 2, further comprising connecting, via the connection manager, to the data source.

5. The method of claim 1, further comprises identifying one or more options specified in the first XML configuration file indicative of generating the second XML configuration file.

6. The method of claim 1, wherein the options specified in the first XML configuration file further comprise a set of display options.

7. The method of claim 1, further comprising storing the first XML configuration file in a memory local to the user terminal.

8. The method of claim 1, further comprising:
transforming the set of data retrieved from the data source in accordance with a predefined format; and
storing the set of data transformed to the predefined format in the database.

9. The method of claim 1, further comprises accessing connection information specified in the second XML configuration file to connect to the data source.

10. A method of retrieving data from a data source, the method comprising:
receiving a set of display options and a set of data retrieval filters from a user terminal via a user interface, wherein the set of display options and the set of data retrieval filters correspond to the data source;
embedding the set of data retrieval filters and the set of display options into a first XML configuration file;
generating a second XML configuration file based on the first XML configuration file, wherein the second XML configuration file includes connection information for connecting with the data source;
retrieving a set of data from the data source in accordance with the set of data retrieval filters embedded in the first XML configuration file and the connection information specified in the second XML configuration file;
storing the set of data in a database in accordance with a predefined format; and
generating one or more data portlets to display the set of data to the user terminal in accordance with display options specified in the first XML configuration file, wherein the one or more data portlets are communicably coupled to an application server and the user interface.

11. The method of claim 10, further comprising:
configuring a plurality of portlets on a portal server based on the first XML configuration file and the second XML configuration file, the plurality of portlets communicating with an application server and the portal server, wherein the application server is communicably coupled to the data source;
retrieving the set of data from the data source via the plurality of portlets operating on the portal server.

12. The method of claim 10, wherein the plurality of portlets further comprises at least two of a connection manager, a viewer application and a configuration manager.

13. The method of claim 12, further comprising:
generating the first XML configuration file by the configuration manager; and
generating the second XML configuration file by the connection manager.

14. The method of claim 10, further comprising storing the first XML configuration file in a memory local to the user.

15. The method of claim 10, further embedding one or more identities of the data source and one or more sets of keywords in the first XML configuration file.

16. A system for exchanging data between a user terminal and a data source, the system comprising:
a user interface configured to receive a data source query from the user terminal, the data source query corresponding to a data source;
a processor configured to generate a first XML configuration file based on the data source query, the first XML configuration file including a set of display options and a set of data retrieval filters; and
a portal server communicably coupled to the user interface, the portal server configured to:
generate a second XML configuration file based on one or more parameters specified in the first XML configuration file, the second XML configuration file including connection information for connecting with the data source;
retrieve a set of data from the data source in accordance with the set of data retrieval filters embedded in the first XML configuration file and the connection information specified in the second XML configuration file;
store the set of data in a database; and
generate one or more data portlets to display the set of data on the user interface in accordance with the display options specified in the first XML configuration file.

17. The system of claim 16, further comprising a plurality of portlets configured by the portal server.

18. The system of claim 17, wherein the plurality of portlets comprises at least two of a connection manager, a viewer application and a configuration manager.

19. The system of claim 18, wherein the portal server is further configured to:
generate the first XML configuration file by the configuration manager; and
generate the second XML configuration file by the connection manager.

20. The system of claim 16, wherein the portal server is further configured to:
transform the set of data retrieved from the data source in accordance with a predefined format; and
store the set of data transformed to the predefined format in the database.
